(19) United States
(12) Patent Application Publication
(10) Pub. No.: US 2024/0198376 A1
(43) Pub. Date: Jun. 20, 2024

(54) LAMINAR DEVICE TO CREATE WATER FEATURE/S

(71) Applicant: Pentair Water Pool and Spa, Inc., Cary, NC (US)

(72) Inventors: Adam Key, Cary, NC (US); Andrew Phy, Apex, NC (US)

(21) Appl. No.: 18/542,290

(22) Filed: Dec. 15, 2023

Related U.S. Application Data
(60) Provisional application No. 63/432,780, filed on Dec. 15, 2022.

(51) Int. Cl. B05B 17/08; B05B 3/02

(52) U.S. Cl. CPC B05B 17/08; B05B 3/025

(57) ABSTRACT

A laminar device is provided. The laminar device includes a collar, an arm lid plate, a first bracket, a second bracket, and a laminar body. The arm lid plate is rotatably enclosed in the collar. The first bracket is opposite the second bracket and extends downwardly in a same direction from the arm lid plate. The laminar body is rotatably coupled to the first bracket and the second bracket and rotates and tilts to create one or more water features.

### CROSS-REFERENCES TO RELATED APPLICATIONS

This application claims priority under 35 U.S.C. § 119 to U.S. Provisional Patent Application No. 63/432,780, filed Dec. 15, 2022, the entire contents of which are incorporated herein by reference.

### BACKGROUND

Swimming pools and other aquatic applications may include components designed to add artistic or aesthetic enhancements to the environment surrounding the aquatic application. The components may be provided in the form of a laminar device that sprays water out of the laminar device to generate different water features. The laminar device is designed to remove turbulence and air bubbles from the water before projecting it through a finely machined nozzle associated with the laminar device. The water flow is non-turbulent so the water steam projected out of the laminar device retains its surface tension and flows out of the laminar device and through the air in a smooth, clean, unbroken stream.

Conventional laminar devices are often fixedly installed in the ground in a hole that is located adjacent to the aquatic application. The laminar devices are frequently installed such that a top cover of the laminar device is flush with the pool or deck surface. Once a laminar device is installed, the angle or direction of the water flow out of the laminar device is difficult to adjust. Thus, such non-adjustable laminar devices offer limited water feature arrangements.

Therefore, there is a need for an improved laminar device that can be used in a wider variety of water feature arrangements and is adjustable so that the water flow can be more easily adapted or adjusted without having to remove the laminar device from its original installation location.

### SUMMARY

Some embodiments provide a laminar device including a collar, an arm lid plate, a first bracket, a second bracket, and a laminar body. The arm lid plate is rotatably enclosed in the collar. The first bracket is opposite the second bracket, and the first bracket and the second bracket extend in a same direction from the arm lid plate. The laminar body is rotatably coupled to the first bracket and the second bracket, whereby the laminar body rotates in at least a first and a second direction and tilts at one or more angles to create one or more water features arrangements.

In some embodiments, the laminar body is rotated and tilted simultaneously to create the one or more water features.

In some embodiments, the first bracket includes a first gear, a second gear, and a first motor. In some embodiments, the first gear, the second gear, and the first motor tilt the laminar body between a first position and a second position relative to the first bracket.

In some embodiments, the arm lid plate comprises a first gear, a second gear, and a first motor. In some embodiments, the first gear, the second gear, and the first motor rotate the laminar body relative to the arm lid plate.

In some embodiments, the laminar body is rotatable in a first direction and a second direction.

In some embodiments, the one or more water features are produced by a laminar stream exiting through the laminar body.

In some embodiments, the laminar body rotates and tilts based on a command provided by a user to a controller in communication with the laminar device. In some embodiments, the command includes an angle for rotating and an angle for tilting the laminar body. In some embodiments, the command includes one or more pre-defined options to create the one or more water features.

In some embodiments, the laminar body comprises one or more lights to generate light patterns along with the one or more water features.

Some embodiments provide a method including receiving a command from a user to create one or more water features using a laminar device, operating a first gear and a second gear using a first motor to tilt a laminar body of the laminar device in response to the command, and operating a third gear and a fourth gear using a second motor to rotate the laminar body in response to the command. Tilting and rotating the laminar body creates the one or more water features through a laminar stream exiting from the laminar body.

In some embodiments, the laminar body is rotated and tilted simultaneously to create the one or more water features.

In some embodiments, the first gear is a spur gear, and the second gear is a pinion gear.

In some embodiments, the third gear is a ring gear, and the fourth gear is a pinion gear.

In some embodiments, the laminar body is tiltable between a first position and second position.

In some embodiments, the laminar body is rotatable in a first direction and a second direction.

Some embodiments provide a system including a laminar device and a controller. The laminar device includes a first motor, a laminar body drivably coupled to the first motor, an arm lid plate supporting the laminar body, and a second motor drivably coupled to the arm lid plate. The controller is in communication with the laminar device to control the first motor and the second motor based on commands provided by a user to create one or more water features, where the operation of the first motor tilts the laminar body and the operation of the second motor rotates the arm lid plate.

### BRIEF DESCRIPTION OF THE DRAWINGS

FIG. 1 is a first side elevational view of a laminar device in a first position;

FIG. 2 is a first side isometric view of the laminar device of FIG. 1 in the first position;

FIG. 3 is a second side isometric view of the laminar device of FIG. 1 in the first position;

FIG. 4 is a bottom isometric view of the laminar device of FIG. 1 in the first position;

FIG. 5 is a top isometric view of the laminar device of FIG. 1 in the first position;

FIG. 6 is an isometric cross-sectional view of the laminar device of FIG. 1 in the first position made along the line Y-Y of FIG. 1;

FIG. 7 is a top isometric view of the laminar device of FIG. 1 in a second position;

FIG. 8 is a side elevational view of the laminar device of FIG. 1 in a third position;

FIG. 9 is a block diagram of various electronic components associated with the laminar device of FIG. 1 in an environment according to the principles of this disclosure; and

FIG. 10 is a flow diagram depicting a method for operating the laminar device of FIG. 1.

### DETAILED DESCRIPTION

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the attached drawings. The invention is capable of other embodiments and of being practiced or of being carried out in various ways. Also, it is to be understood that the phraseology and terminology used herein are for the purpose of description and should not be regarded as limiting. For example, the use of “including,” “comprising,” or “having” and variations thereof herein is meant to encompass the items listed thereafter and equivalents thereof as well as additional items.

As used herein, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings.

As used herein, unless otherwise specified or limited, “at least one of A, B, and C,” and similar other phrases, are meant to indicate A, or B, or C, or any combination of A, B, and/or C. As such, this phrase, and similar other phrases can include single or multiple instances of A, B, and/or C, and, in the case that any of A, B, and/or C indicates a category of elements, single or multiple instances of any of the elements of the categories A, B, and/or C.

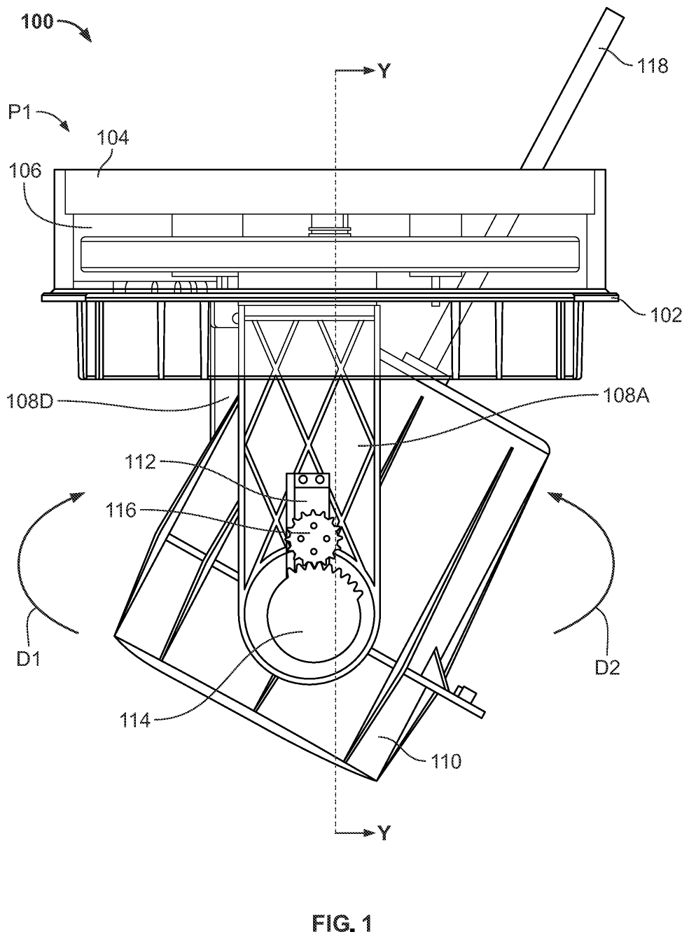

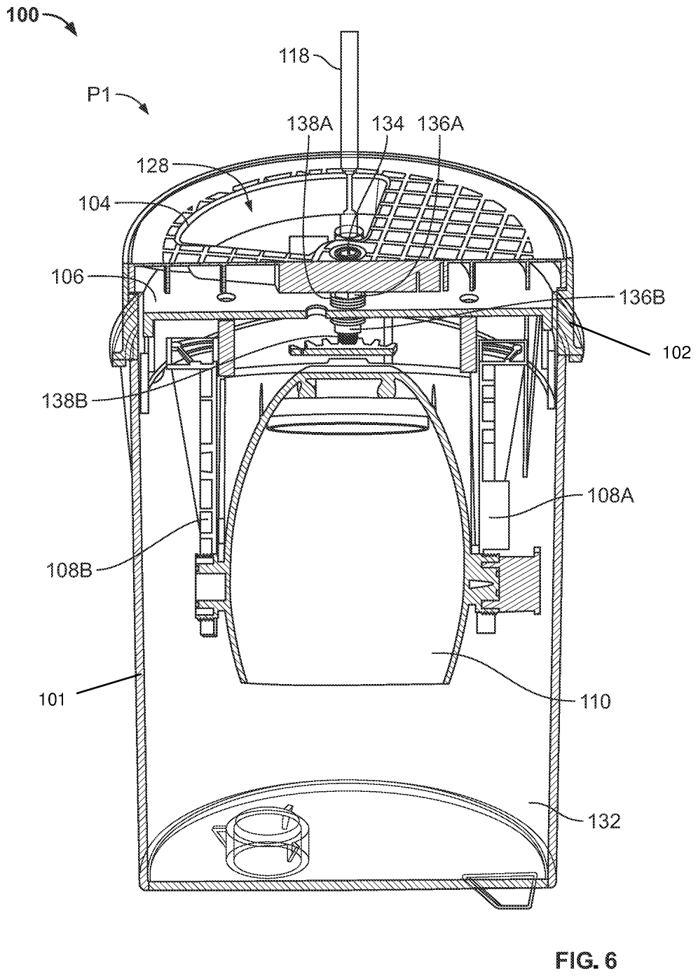

As explained above, it would be useful to provide an improved laminar device that is adjustable, repositionable, and remote-controllable to generate water features for an aquatic application. More particularly, FIG. 1 illustrates a laminar device 100 according to one embodiment. The laminar device 100 includes an exterior laminar housing 101 (see FIG. 6) and a collar 102 designed to releasably interact with the housing 101 to form an enclosure. The laminar housing 101 is configured to shield the laminar device 100 from dust, rain, wind, etc. The collar 102 is defined by a stepped cylindrical body having a lower portion and an upper portion provided in the form of an arm lid plate 106. A ridge circumscribes and protrudes outwardly from the body and delineates the lower portion and the upper portion.

The device 100 further includes a laminar cover 104 designed to be releasably secured to the upper portion of the collar 102 (e.g., the arm lid plate 106) via an interference fit. The collar 102 receives, surrounds, and supports the laminar cover 104 and the arm lid plate 106. Additionally, the arm lid plate 106 rotatably attaches to the laminar cover 104 inside the collar 102 and is rotatable relative to collar 102. In some embodiments, the collar 102, laminar cover 104, and or arm lid plate 106 are rounded and/or circular.

Various additional components are included in the laminar device 100 including a laminar body 110, a laminar light engine 204, a laminar fiber optic adapter, a laminar screen kit, and the like. In some instances, the laminar light engine 204 is provided within or otherwise associated with the laminar body 110.

In the configuration depicted in FIG. 1, the laminar body 110 is rotated to a first position P1 relative to the collar 102, the laminar cover 104, the arm lid plate 106, the first bracket 108A, and the second bracket 108B. The first elongate bracket 108A and the second elongate bracket 108B protrude downwardly in a substantially parallel manner from the arm lid plate 106 (see also FIG. 6). The laminar body 110 is coupled to each of the first bracket 108A and the second bracket 108B on opposing sides thereof. The laminar body 110 is held by and rotatably engaged with each of the first bracket 108A and the second bracket 108B. In some embodiments, each of the first bracket 108A and the second bracket 108B are provided in the form of rectilinear components having a curved end.

Still referring to FIG. 1, the first bracket 108A includes a first motor 112, a first gear 114, and a second gear 116. In some embodiments, the first gear 114 is provided in the form of a spur gear and the second gear 116 is a pinion gear. The first motor 112 receives one or more control signals input by a user (not shown). Based on the control signals, the first motor 112 operates the first gear 114 and the second gear 116 to rotate the laminar body 110 relative to the first bracket 108A and the second bracket 108B. Thus, the laminar body 110 is rotatable in a first direction D1 and a second direction D2. In some embodiments, the first direction D1 is an upward direction, and the second direction D2 is a downward direction. The first motor 112 may be any type of suitable motor (e.g., servo, stepper, brushed, brushless, etc.).

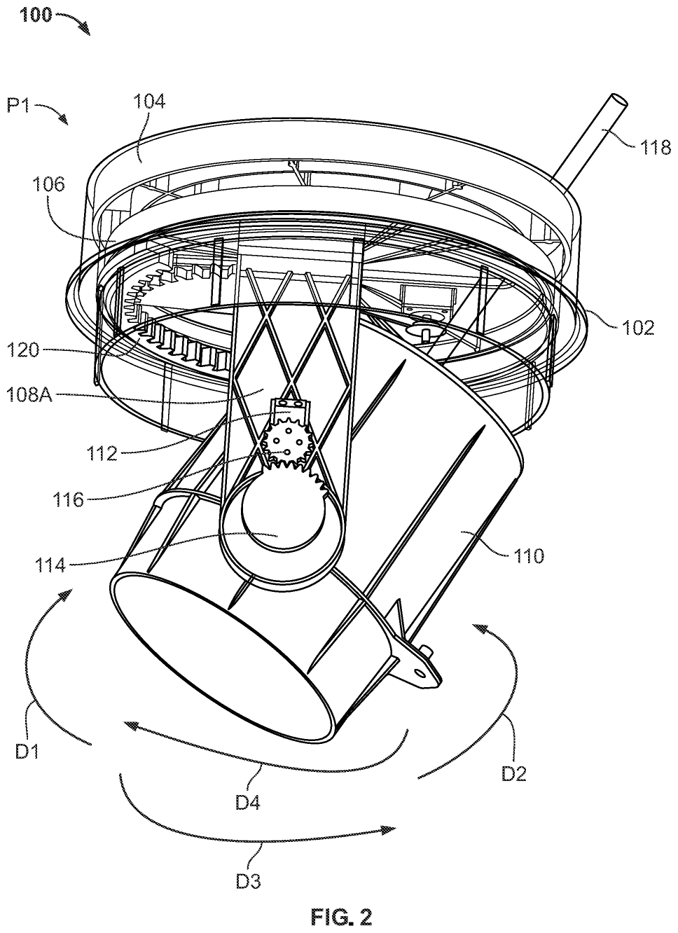

As illustrated in FIG. 2, the collar 102 includes a third gear 120 circumscribing the interior of the collar 102. In some instances, the third gear 120 is provided in the form of an inwardly extending ring gear.

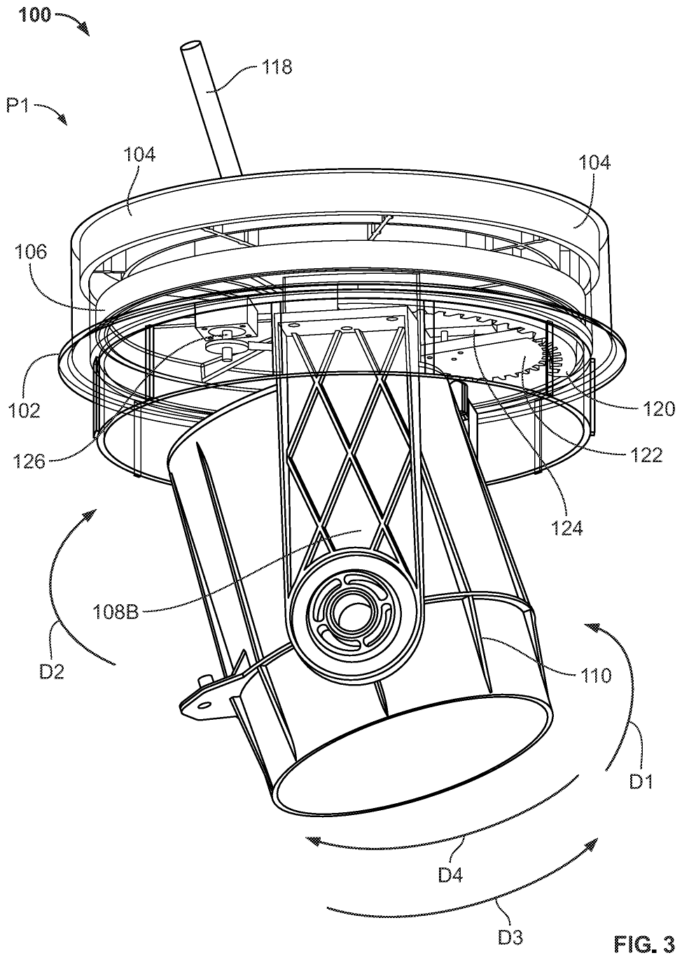

As shown in FIG. 3, the laminar body 110 is rotatably supported by the second bracket 108B. Further, the arm lid plate 106 includes a fourth gear 122 and a second motor 124. In some embodiments, the fourth gear 122 is provided in the form of a pinion gear. The second motor 124 is designed to receive one or more control signals input by the user (not shown). Based on the control signals, the second motor 124 operates the third gear 120 and the fourth gear 122 to rotate the laminar body 110 relative to the collar 102, the laminar cover 104, and the arm lid plate 106. Thus, the laminar body 110 is rotatable in a third direction D3, and a fourth direction D4. In some embodiments, the third direction D3 is a clockwise direction, and the fourth direction D4 is a counterclockwise direction. The second motor 124 may be any type of suitable motor (e.g., servo, stepper, brushed, brushless, etc.).

As best seen in FIGS. 2 and 3, given a supply of water under pressure, the laminar body 110 produces a laminar stream 118 that projects upwardly through the laminar cover 104. In operation, the orientation of the laminar stream 118 varies as the laminar body 110 is rotated or tilted by the first motor 112 and the second motor 124 relative to the collar 102, the first bracket 108A, and the second bracket 108B. Thus, by manipulating the laminar body 110 in one or more of the first direction D1, the second direction D2, the third direction D3, and the fourth direction D4, the laminar stream 118 moves to create one or more water features.

Referring to FIG. 3, the laminar device 100 also includes a fiber optic adapter 126 installed on the arm lid plate 106. The fiber optic adapter 126 includes a third motor and a blade (not shown). The third motor receives control signals input by the user (not shown). Based on the control signals, the third motor operates the blade to disrupt the laminar stream 118. Disruption of the laminar stream 118 creates a visual effect in addition to the directional control of the laminar stream 118.

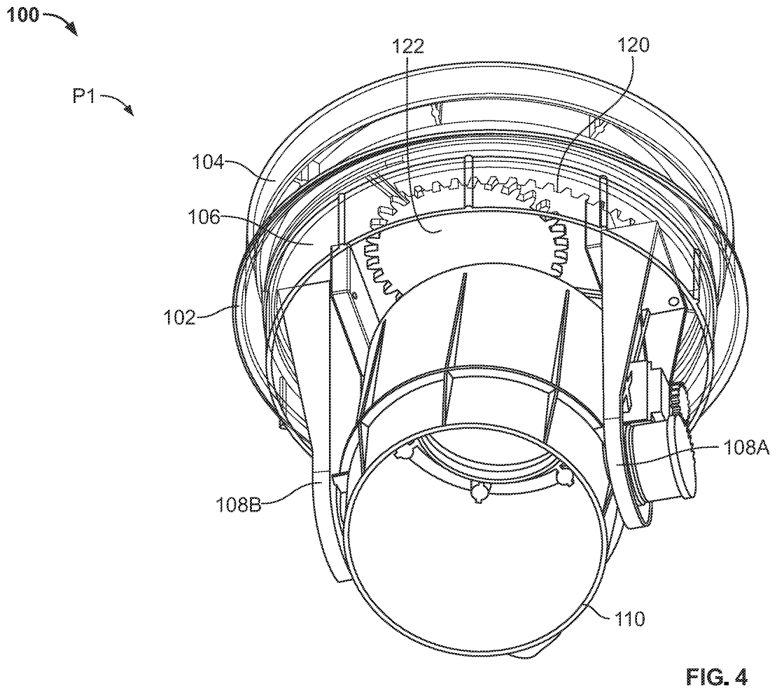

Referring now to FIG. 4, the fourth gear 122 meshes with the third gear 120. When the laminar device 100 is installed, the collar 102 is fixed relative to the installation site. Thus, the third gear 120 provides a reaction force for the fourth gear 122. Further, when the fourth gear 122 rotates, the fourth gear 122 meshingly engages against the third gear 120 to move in a path within the third gear 120. As the fourth gear 122 moves within the third gear 120, the arm lid plate 106, the first bracket 108A, the second bracket 108B, and the laminar body 110 rotate relative to the collar 102.

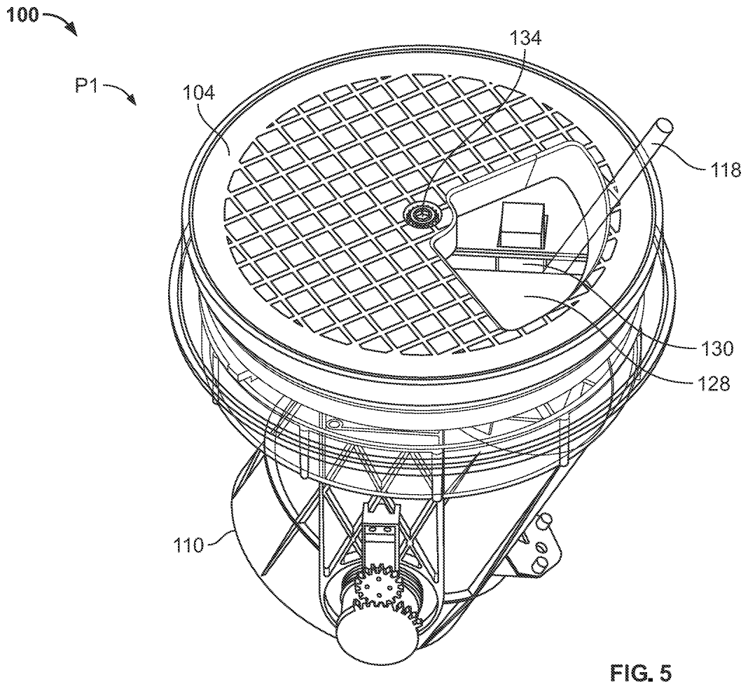

As depicted in FIG. 5, the laminar cover 104 defines an opening 128 and the arm lid plate 106 defines a slot 130. In operation, the laminar stream 118 travels from the laminar body 110 and passes through the opening 128 and the slot 130 to exit the laminar device 100. In some embodiments, the opening 128 is shaped as an annular sector and/or curvilinearly trapezoidal, as shown in FIG. 5. It should be understood the opening 128 may be any suitable shape (e.g., rectangular, oval, circular, etc.). In some embodiments, the slot 130 is rectangular, as depicted in FIG. 5. It should also be understood that the slot 130 may be any suitable shape (e.g., elongated ovular, teardrop, keyhole, etc.).

As illustrated in FIG. 6, the first bracket 108A and the second bracket 108B are positioned opposite each other to rotatably support the laminar body 110. Additionally, the laminar device 100 includes a center bolt 134, a first nut 136A, a second nut 136B, a first thrust bearing 138A, and a second thrust bearing 138B. The center bolt 134 passes through the arm lid plate 106 and provides an axis for the arm lid plate 106 to rotate about. The arm lid plate 106 is positioned on the center bolt 134 directly between the first thrust bearing 138A and the second thrust bearing 138B. The first thrust bearing 138A is between the first nut 136A and the arm lid plate 106 along the center bolt 134, and the second thrust bearing 138B is between the second nut 136B and the arm lid plate 106 along the center bolt 134.

Still referring to FIG. 6, the first nut 136A threadably engages the center bolt 134 to retain the first thrust bearing 138A against the arm lid plate 106. The second nut 136B threadably engages the center bolt 134 to retain the second thrust bearing 138B against the arm lid plate 106. Thus, the first nut 136A, the first thrust bearing 138A, the second nut 136B, and the second thrust bearing 138B hold the arm lid plate 106 in a fixed vertical position along the center bolt 134. The arm lid plate 106 rotates relative to the first nut 136A and the second nut 136B via the first thrust bearing 138A and the second thrust bearing 138B, respectively. Thus, the arm lid plate 106 rotates about the center bolt 134.

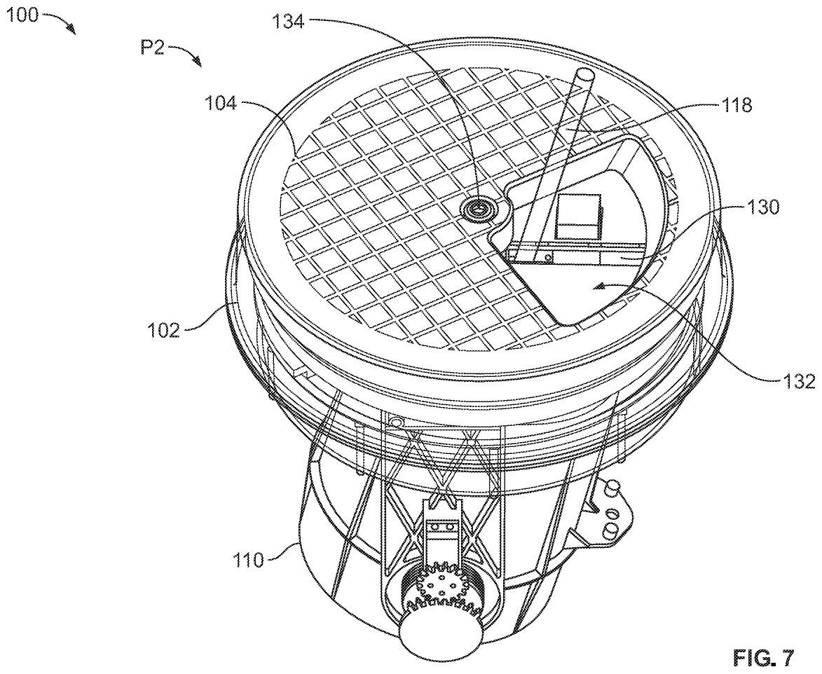

FIG. 7 illustrates the laminar device 100 in a second position P2. In the second position P2, the laminar body 110 is rotated and/or tilted more upwardly relative to the collar 102 than in the first position P1 illustrated in FIG. 5. Thus, in the second position P2, the laminar stream 118 exits the laminar device 100 closer to the center bolt 134 than in the first position P1.

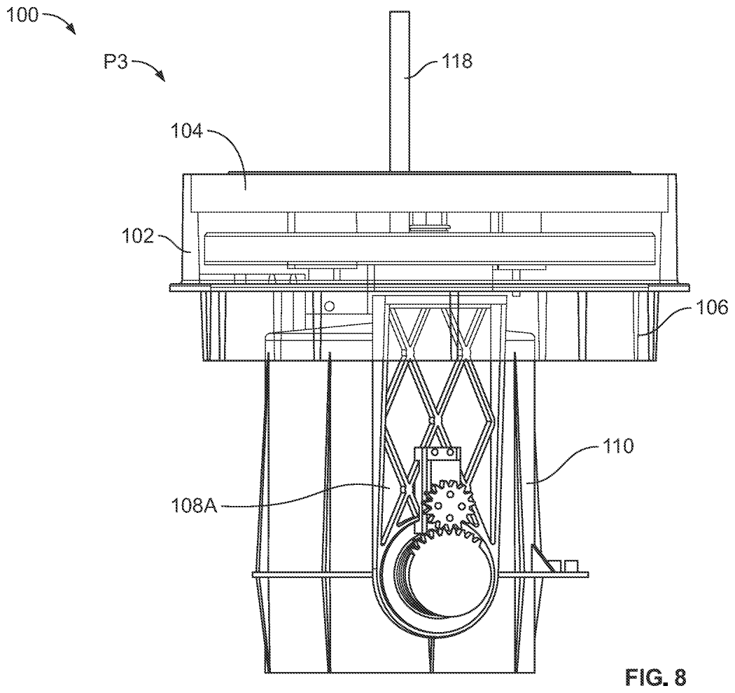

FIG. 8 illustrates the laminar device 100 in a third position. In the third position P3, the laminar body 110 is rotated and/or tilted more upwardly relative to the collar 102 than in the second position P2 illustrated in FIG. 5. More specifically, in the third position P3, the laminar stream 118 exits the laminar device 100 substantially perpendicularly to the laminar cover 104.

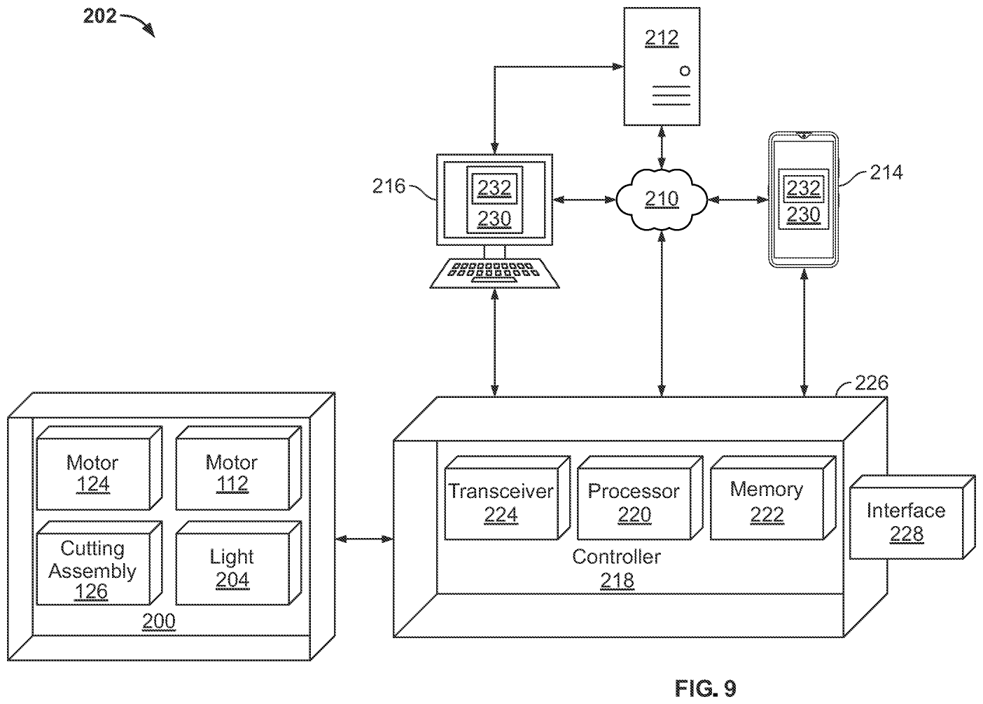

FIG. 9 illustrates electronic components 200 associated with the laminar device 100 of FIGS. 1-8 operating in an environment 202. The electronic components 200 include the first motor 112, second motor 124, and fiber optic adapter 126. The electronic components 200 also include a laminar light engine 204 of the laminar device 100 that selectively illuminates the laminar stream 118 to produce light patterns in the laminar stream 118.

The environment 202 also includes a network 210, a server 212, a mobile device 214, a computing device 216, and a controller 218. The server 212, the mobile device 214, the computing device 216, and the controller 218 are interconnected with one another via the network 210. In some instances, the computing device 216 is directly connected to the server 212 and/or the mobile device 214. The network 210, the server 212, the mobile device 214, the computing device 216, and the controller 218 may be connected to one another wirelessly (e.g., via Wi-Fi, Bluetooth, a cellular network, etc.) and/or via a wired connection (e.g., CAT5, USB, LAN, WAN, etc.). In some instances, the mobile device 214 and the computing device 216 are connected to the controller 218 wirelessly, thus permitting a generally constant data stream from the controller 218 to the mobile device 214 and/or the computing device 216. In some instances, the mobile device 214 and the computing device 216 are connected to the controller 218 via a wired connection through which data from the controller 218 is occasionally uploaded and/or downloaded (e.g., to update water feature patterns to be performed by the laminar device 100). Further, in some instances, the controller 218 is connected to the network 210 wirelessly and/or via a wired connection.

The controller 218 includes a processor 220, a memory 222, and a transceiver 224. In some embodiments, the processor 220, the memory 222, and the transceiver 224 are supported in a housing 226. In some embodiments, the controller 218 also includes a first interface 228 that is externally supported by the housing 226 and thus accessible to a user. The controller 218 communicates with the first motor 112, the second motor 124, the fiber optic adapter 126, and the laminar light engine 204. The transceiver 224 is configured to wirelessly communicate with the network 210, the mobile device 214, and the computing device 216. In operation, a user inputs commands for a desired water feature into the controller 218 via the first interface 228. The controller 218 controls the first motor 112, the second motor 124, the fiber optic adapter 126, and/or the laminar light engine 204 based on the commands. Thus, the first motor 112, the second motor 124, the fiber optic adapter 126, and the laminar light engine 204 manipulate the laminar device 100 of FIGS. 1-8 to dispense the water feature from the laminar device 100 in a specific orientation, light arrangement, pattern, and/or display.

The mobile device 214 and/or the computing device 216 run an application 230 to control the first motor 112 and the second motor 124. Thus, the first motor 112, the second motor 124, the fiber optic adapter 126, and the laminar light engine 204 are remotely controllable via the application 230. Additionally, the application 230 includes a second interface 232. In operation, a user configures the controller 218 in the application 230 via the second interface 232. Further, the user inputs commands for a desired water feature into the application 230 via the second interface 232. The application 230 sends the commands to the controller 218, which controls one or more of the first motor 112, the second motor 124, the fiber optic adapter 126, and the laminar light engine 204 based on the electronic commands. Thus, commands to perform desired water features may be input by a user to the mobile device 214, the computing device 216, and/or directly to the controller 218 via the first interface 228 and/or the second interface 232.

Referring still to FIG. 9, the processor 220 may be any suitable processing device or set of processing devices such as, but not limited to a microprocessor, a microcontroller-based platform, a suitable integrated circuit, one or more field programmable gate arrays (FPGAs), and/or one or more application-specific integrated circuits (ASICs). The memory 222 may be any suitable memory type (e.g., volatile memory, non-volatile memory, unalterable memory, read-only memory, high-capacity storage devices, etc.).

The memory 222 is provided in the form of a machine-readable medium on which one or more sets of instructions, such as the software for operating the methods of the present disclosure can be embedded. The embedded instructions may embody one or more of the methods or logic as described herein. In a particular embodiment, the embedded instructions may reside completely, or at least partially, within any one or more of the memory 222, the computer-readable medium, and/or within the processor 220 during the execution of the instructions.

The terms “non-transitory computer-readable medium” and “tangible computer-readable medium” should be understood to include a single medium or multiple media, such as a centralized or distributed database, and/or associated caches and servers that store one or more sets of instructions. The terms “non-transitory computer-readable medium” and “tangible computer-readable medium” also include any tangible medium that is capable of storing, encoding, or carrying a set of instructions for execution by a processor or that causes a system to perform any one or more of the methods or operations disclosed herein. As used herein, the term “tangible computer-readable medium” includes any type of computer-readable storage device and/or storage disk and excludes propagating signals.

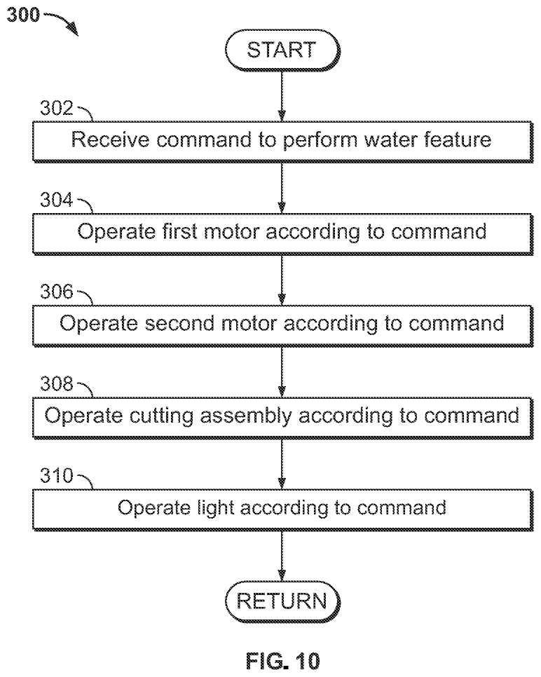

FIG. 10 illustrates a flow diagram depicting a first method 300 for operating the laminar device 100 of FIGS. 1-8 according to the principles of this disclosure. The method 300 starts at step 302, where the controller 218 receives one or more commands to create one or more water features using the laminar device 100. In some embodiments, the user inputs commands to perform the water feature input via the first interface 228 of the controller 218. In some embodiments, the user inputs commands to perform the water feature via the second interface 232 of the mobile application 230 installed on the mobile device 214 and/or the computing device 216.

In some embodiments, the commands from the user include angles for rotating the laminar body 110 relative to the collar 102 and/or laminar cover 104. In some embodiments, the commands from the user include angles for tilting the laminar body 110 relative to the collar 102, the laminar cover 104, the arm lid plate 106, the first bracket 108A, and/or the second bracket 108B. For example, the user may provide an input to tilt the laminar body 110 at 30 degrees relative to the first bracket 108A. As another example, the user may provide an input to rotate the laminar body 110 at 70 degrees relative to the collar 102.

In some embodiments, inputs from the user include one or more pre-defined options to create one or more water features. The one or more pre-defined options correspond to one or more pre-defined tilt angles to tilt the laminar body 110 and one or more pre-defined rotate angles to rotate the laminar body 110. For example, the user may provide an input by selecting a first tilt option which is preconfigured to tilt the laminar body 110 at 20 degrees relative to the first bracket 108A. As another example, the user may provide an input by selecting a first rotation option which is preconfigured to rotate the laminar body 110 at 50 degrees relative to the collar 102. The one or more pre-defined tilt angles and the one or more pre-defined rotate angles can be reconfigured by the user via the first interface 228 and/or the second interface 232. The method 300 proceeds to step 304.

At step 304, the controller 218 operates the first motor 112 according to the command input by the user. Thus, the first gear 114 and the second gear 116 are driven by the first motor 112 to tilt the laminar body 110 according to the command. The method 300 proceeds to step 306

At step 306, the controller 218 operates the second motor 124 according to the command input by the user. Thus, the fourth gear 122 is driven against the third gear 120 to rotate the laminar body 110 according to the command. The method proceeds to step 308.

At step 308, the controller 218 optionally operates the fiber optic adapter 126 according to the command input by the user. Thus, the fiber optic adapter 126 is actuated to selectively disrupt the laminar stream 118 according to the command. The method proceeds to step 310.

At step 310, the controller 218 operates the laminar light engine 204 according to the command input by the user. Thus, the laminar light engine 204 selectively illuminates the laminar stream 118 according to the command.

In some embodiments, step 304, step 306, step 308, and/or step 310 may be performed simultaneously. Thus, the controller 218 may tilt the laminar body 110, rotate the laminar body 110, disrupt the laminar steam 118, and/or illuminate the laminar stream 118 at the same time. In further instances, one or more steps may be omitted (e.g., the laminar body 110 only rotates and does not tilt, the laminar body 110 tilts, but does not rotate, the laminar body 110 is illuminated, but does not rotate or tilt, etc.).

In some embodiments, pre-defined command options include simultaneous tilt motions, rotation motions, stream disruption, and stream illuminations. Thus, by tilting and rotating the laminar body 110 and selectively disrupting and illuminating the laminar stream 118, the laminar stream 118 exiting the laminar body 110 is manipulated, redirected, interrupted, and/or lit to produce an aesthetically pleasing and/or entertaining water feature. The method 300 then returns to step 302 to produce additional desired water features.

Technical advantages of the present disclosure include (a) a vast range of laminar water features, (b) automatic rotation, tilt, stream emission, and stream lighting of the laminar device, (c) elimination of manual rotation, tilt, stream emission, and stream lighting of the laminar device, (d) remote operation or control of the laminar device, and (e) angular, directional, stream emission, and stream lighting adjustment of the laminar device.

In other embodiments, other configurations are possible. For example, those of skill in the art will recognize, according to the principles and concepts disclosed herein, that various combinations, sub-combinations, and substitutions of the components discussed above can provide water features using different configurations of motors, lights, electronic assemblies, and so on, under a variety of operating conditions.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein. The entire disclosure of each patent and publication cited herein is incorporated by reference, as if each such patent or publication were individually incorporated by reference herein. Various features and advantages of the disclosure are set forth in the following claims.

What is claimed is:

1. A laminar device for an aquatic application, comprising:
a substantially cylindrical housing forming an enclosure and having an opening at a top end thereof;
a collar designed to releasably engage the opening of the housing;
an arm lid plate rotatably enclosed in the collar;
a first bracket opposite a second bracket, the first bracket and the second bracket extending downwardly in a same direction from the arm lid plate; and
a laminar body rotatably coupled to the first bracket and the second bracket, wherein the laminar body rotates and tilts to create one or more water features.

2. The laminar device of claim 1, wherein the first bracket includes a first gear, a second gear, and a first motor associated therewith.

3. The laminar device of claim 2, wherein the first gear, the second gear, and the first motor are designed to tilt the laminar body relative to the first bracket.

4. The laminar device of claim 3, wherein the laminar body is tiltable between a first position and a second position with respect to the first bracket.

5. The laminar device of claim 1, wherein the arm lid plate includes a first gear, a second gear, and a first motor.

6. The laminar device of claim 5, wherein the first gear, the second gear, and the first motor rotate the laminar body relative to the arm lid plate.

7. The laminar device of claim 6, wherein the laminar body is rotatable in a first direction and a second direction opposite the first direction.

8. The laminar device of claim 1, wherein a first water feature of the one or more water features is produced when the laminar body is in a first orientation.

9. The laminar device of claim 1, wherein the laminar body rotates based on a command provided by a user to a controller in communication with the laminar device to produce a second water feature of the one or more water features that exits the laminar body having a different fluid flow path than the first water feature.

10. The laminar device of claim 9, wherein the command includes a first angle for rotating the laminar body and a second angle for tilting the laminar body.

11. The laminar device of claim 10, wherein the command includes one or more pre-defined options to create the one or more water features.

12. The laminar device of claim 1, wherein the laminar body includes a laminar light engine to generate one or more light patterns.

13. The laminar device of claim 1, wherein the laminar body is rotated and tilted simultaneously to create the one or more water features.

14. A laminar device for producing a water feature, comprising:
a laminar housing;
a cover releasably attached to the housing;
an opening in the cover designed to allow a stream of water to flow therethrough;
a collar defined by a stepped body having a lower portion and an upper portion provided in the form of an arm lid plate;
a bracket extending downwardly from the arm lid plate,
a laminar body attached to the bracket, the laminar body including a laminar light engine; and
a motor in communication with the laminar body and designed to move the laminar body relative to the cover.

15. The laminar device for producing a water feature of claim 14, wherein the motor is associated with the bracket and is designed to tilt the laminar body with respect to the bracket.

16. The laminar device for producing a water feature of claim 14, wherein the motor is associated with the arm lid plate and is designed to rotate the laminar body with respect to the cover.

17. The laminar device for producing a water feature of claim 14 further including a controller in communication with the laminar device to control the motor to effectuate one or more commands including tilting the laminar body, rotating the laminar body, adjusting the light intensity of the laminar light engine, disrupting the water feature, starting the water feature, or stopping the water feature.

18. The laminar device for producing a water feature of claim 17, wherein at least two of the one or more commands are substantially simultaneously accomplished.

19. A method of creating a first water feature and a second water feature with a laminar device, the method comprising:
providing the laminar device including a laminar body and an arm lid plate having a bracket extending downwardly therefrom and including a first motor, a first gear, and a second gear, the arm lid plate further including a second motor, a third gear, and a fourth gear associated with the lid plate;
receiving a first command to operate the first gear and the second gear via the first motor to create the first water feature by tilting the laminar body in a first position to create the first water feature; and
receiving a second command to operate the third gear and the fourth gear via the second motor to create the second water feature by rotating the laminar body in a second position different from the first position to create the second water feature.

20. The method of claim 19, wherein the first and second commands are executed substantially simultaneously.
